(19) United States
(12) Patent Application Publication
(10) Pub. No.: US 2009/0064863 A1
(43) Pub. Date: Mar. 12, 2009

(54) Tempering Device

(76) Inventor: Franz-Josef Elsland, Bietigheim (DE)

Correspondence Address: PATENTANWAELTE LICHTI + PARTNER GBR, POSTFACH 41 07 60, D-76207, KARLSRUHE, DE

(21) Appl. No.: 11/992,289

(22) PCT Filed: Sep. 25, 2006
(86) PCT No.: PCT/EP2006/009277

§ 371 Date: Mar. 20, 2008

(30) Foreign Application Priority Data
Sep. 27, 2005 (DE) 10 2005 046 112.3

(51) Int. Cl. B01D 19/00

(52) U.S. Cl. 96/174; 96/194

(57) ABSTRACT

A tempering device for tempering a consumption device comprises a tempering circuit in which a tempering liquid can be circulated by a pump P, and a ventilation device which is disposed in the tempering circuit, by means of which a gas contained in the tempering liquid can be separated therefrom. In order to degas the tempering liquid as quickly as possible, the ventilation device comprises a flow divider in the form of a gravity separator which is disposed in the tempering circuit upstream of the pump, and a ventilation tank which is connected to the gravity separator via a ventilation line. A partial flow of the tempering liquid that flows in the tempering circuit is supplied to the ventilation tank via the ventilation line, wherein a feedback line is additionally provided between the ventilation tank and the tempering circuit, through which tempering liquid that collects in the ventilation tank is returned to the tempering circuit.

The invention concerns a tempering device for tempering a consumption device, with a tempering circuit in which a tempering liquid can be circulated by means of a pump, and a ventilation device disposed in the tempering circuit, by means of which gas contained in the tempering liquid can be separated.

A tempering device of this type is used e.g. for tempering a consumption device in the form of chemical, biological or biochemical reactors, autoclaves, cryostats, evaporators, condensers or other process means which require exact temperature control or regulation. It includes a tempering circuit with integrated consumption device and a pump which circulates the tempering liquid in the tempering circuit. The tempering circuit moreover has a cooling device and/or a heating device. At least one temperature sensor detects the actual temperature of the tempering liquid or the consumption device to be tempered, and emits a corresponding signal to a control unit in which the actual temperature is compared with a desired temperature. In dependence on the comparison, the control unit drives the cooling device or the heating device in order to bring or maintain the tempering liquid to/at the desired temperature.

The tempering liquid contains a small amount of dissolved moisture (water) in the initial or supply state, which boils off at temperatures of around 100° C. in the form of water vapor and causes substantial problems in the tempering device. Similar problems arise when the tempering liquid consists of a substance mixture, wherein the more volatile portions degas at high temperatures similar to water vapor.

When a tempering device is used in a chemical laboratory, the tempering liquid of the tempering device is usually selected in correspondence with the desired application and is exchanged if necessary. When the tempering liquid is exchanged, residual amounts of the old tempering liquid as well as cleaning agents remain in the tempering circuit. These components often have a lower boiling point than the new tempering liquid and produce gas when heated.

An excessive residual gas portion in the tempering liquid causes problems, in particular, with the pumps and the heating device. Since pumps are designed to supply liquids having only a small gas portion, the output of the pump drastically drops when the gas portion of the liquid to be supplied is high. Continuous supply of the tempering liquid in the tempering circuit is therefore not possible. When the tempering liquid supply is temporarily interrupted due to a high gas portion at the pump, there is no constant passage of tempering liquid at the heating device, which can cause overheating of the heating device.

The gas that forms due to the moisture (water) contained in the tempering liquid or the slightly volatile portions must be removed from the tempering liquid, which is called boiling-out, out-gassing or degassing. Towards this end, a gravity separator is conventionally provided in the tempering circuit, in which the gas contained in the tempering liquid can rise due to its low density, and be supplied to a ventilation tank. It has, however, turned out that degassing of the tempering liquid within the separator occurs very slowly due to the lifting force of the gas alone, and that the tempering device requires a very long preparatory time until the actual tempering process can be started.

It is the underlying purpose of the invention to create a tempering device of the above-mentioned type which permits fast degassing of the tempering liquid.

This object is achieved in accordance with the invention with a tempering device comprising the characterizing features of claim 1. The ventilation device thereby comprises a flow divider in the form of a gravity separator, which is disposed upstream of or on the suction-side of the pump in the tempering circuit and comprises a ventilation tank which is connected to the gravity separator via a ventilation line. A partial flow of the tempering liquid that flows in the tempering circuit is branched off in the gravity separator and supplied to the ventilation tank via the ventilation line, which is under atmospheric pressure. A feedback line additionally extends between the ventilation tank and the tempering circuit, through which the tempering liquid that collects in the ventilation tank can be returned to the tempering circuit.

In the inventive tempering device, the gas bubbles are initially separated from the tempering liquid in the gravity separator which is disposed upstream of the pump. The flow of the tempering liquid is divided into two partial flows in the gravity separator. A main stream extends further through the tempering circuit to the pump. The gas bubbles rise in the gravity separator and reach the ventilation line which is preferably connected in the upper area of the gravity separator, and in which they can flow in a side stream to the ventilation tank, where they can escape into the atmosphere. The tempering liquid that is carried along in the side flow through the ventilation line is collected in the ventilation tank and returns without gas to the tempering circuit via the feedback line. Degassing is therefore performed using a small circulating partial or side flow of the tempering liquid which can degas in the atmospheric ventilation tank. It has turned out that this yields fast and effective degassing of the tempering liquid.

A separation chamber is provided inside the gravity separator, in which less dense and heavier components are separated through gravity. It has turned out to be advantageous for the separator chamber to have only a relatively small volume of 100 ml to 500 ml and, in particular, 200 ml to 300 ml.

Since the pressure in the ventilation tank preferably corresponds to atmospheric pressure, the pressure in the gravity separator is larger than the pressure in the ventilation tank. For this reason, the gas bubbles preferably enter the partial or side flow and gain access to the ventilation tank.

In a preferred embodiment of the invention, the feedback line terminates again in the tempering circuit between the pump and the gravity separator.

The tempering liquid is usually only degassed prior to the actual tempering process. For this reason, in a further development of the invention, the ventilation line and/or the feedback line may comprise a stop valve.

In accordance with the invention, degassing is effected only by means of a hydraulic circuit which requires no valves in the main stream or the tempering circuit. This is advantageous in that the valves that are positioned in the main flow must be designed for the maximum passage and the overall temperature range of the tempering device, e.g. from −100° C. to +300° C. This is unfavorable in view of cost and space requirements. In the inventive hydraulic circuit, the partial or side flow or degassing flow is only connected via the stop valve disposed in the ventilation line and/or the feedback line, which may be a relatively small magnetic valve having a limited temperature range. Water e.g. is degassed at temperatures of between 100° C. and 120° C., such that the stop valve is only exposed to relatively low media temperatures.

The passage in the ventilation line or the partial or side flow is determined by the pressure drop between the connection of the ventilation line in the gravity separator and the opening or entry point of the feedback line into the tempering circuit. This pressure drop is due to the construction of the tempering circuit and does not have to be produced through further constructive measures.

In a preferred embodiment of the invention, the gas portion and, in particular, the air portion in the tempering liquid e.g. downstream of the pump is determined directly or indirectly using a measuring device.

In another embodiment of the invention, the measuring device may comprise a pressure sensor which is disposed e.g. downstream of the pump and, in particular, directly at the pump outlet, which detects the fluid pressure in the tempering circuit. The pressure sensor sends a corresponding signal to a control unit. The control unit can drive, i.e. open or close, the stop valve in the ventilation line and/or the feedback line and/or change the rotational speed of the pump in dependence on the pressure signal. If there is still an excessive portion of gas or air in the tempering liquid, the pressure at the outlet of the pump will drop at least temporarily. This pressure drop can be detected, upon which the control unit initiates the degassing process. During the degassing process, the pressure sensor and the control unit can moreover monitor whether the portion of gas or air in the tempering liquid is sufficiently reduced to be able to terminate the degassing process, or whether it shall be continued.

The rotational speed of the pump is changed by the control unit prior to or during the degassing process in order to improve the flow division in the gravity separator, since the flow of the tempering liquid thereby becomes smoother.

Alternatively or in addition to the measurement of the pressure in the tempering circuit, the measuring device may comprise a sensor for detecting the power input of the electric pump. As soon as air or gas bubbles are in the tempering liquid, the power input of the electric pump considerably drops. This can be detected by means of the sensor which subsequently emits a corresponding signal to the control unit which then controls the degassing process as mentioned above.

When the tempering liquid includes gas or air bubbles, the air permeability is changed or the tempering liquid is clouded. This can be detected by an optical sensor which emits a corresponding signal to the control unit which controls the degassing process as mentioned above.

The measuring device may additionally or alternatively comprise a calorimetric means for identifying the gas portions in the tempering liquid, and emit corresponding signals to the control unit.

A constructively simple solution for detecting the pressure in the tempering liquid downstream of the pump uses a pressure switch which has a fixed switching point or a differential pressure switch which has a fixed switching point.

In one feasible embodiment of the invention, the ventilation line may terminate in the ventilation tank above the liquid level of the liquid contained in the ventilation tank, such that the opening of the ventilation line is in the atmosphere. The ventilation line may alternatively terminate in the ventilation tank below the liquid level of the liquid contained in the ventilation tank.

In one advantageous further development of the invention, the ventilation line terminates in the feedback line below the ventilation tank. A further gravity separator is preferably provided at the opening location, such that the partial or side flow, which is supplied via the ventilation line, enters the further gravity separator, in which the less dense and denser components are separated. The less dense components, i.e. the gas and air bubbles, rise in the further gravity separator and gain access to the ventilation tank. The denser components return to the tempering circuit via the feedback line.

On rare occasions, there might be the danger that gas explodes or is ignited on or in the ventilation tank. This risk can be considerably reduced by cooling the ventilation tank and, in particular, its interior. In a further development of the invention, the ventilation tank has an associated cooling device which preferably introduces, in particular sprays, a cooled liquid into the ventilation tank.

In the gravity separator disposed in the tempering circuit, a partial or side flow is branched off from the main stream and supplied to the ventilation line. This partial or side flow in the ventilation line should preferably comprise 0.01% to 20% and, in particular 2% to 8% of the overall flow of the tempering liquid that enters the gravity separator. It has turned out that degassing occurs quickly when the partial or side flow in the ventilation line is approximately 4% to 5% of the overall flow of the tempering liquid that enters the gravity separator.

Degassing of the tempering liquid is usually performed prior to the actual tempering process. Degassing of the tempering liquid can, however, also be carried out during the tempering process.

Further details and features of the invention can be extracted from the following description of embodiments of the invention with reference to the attached drawings.

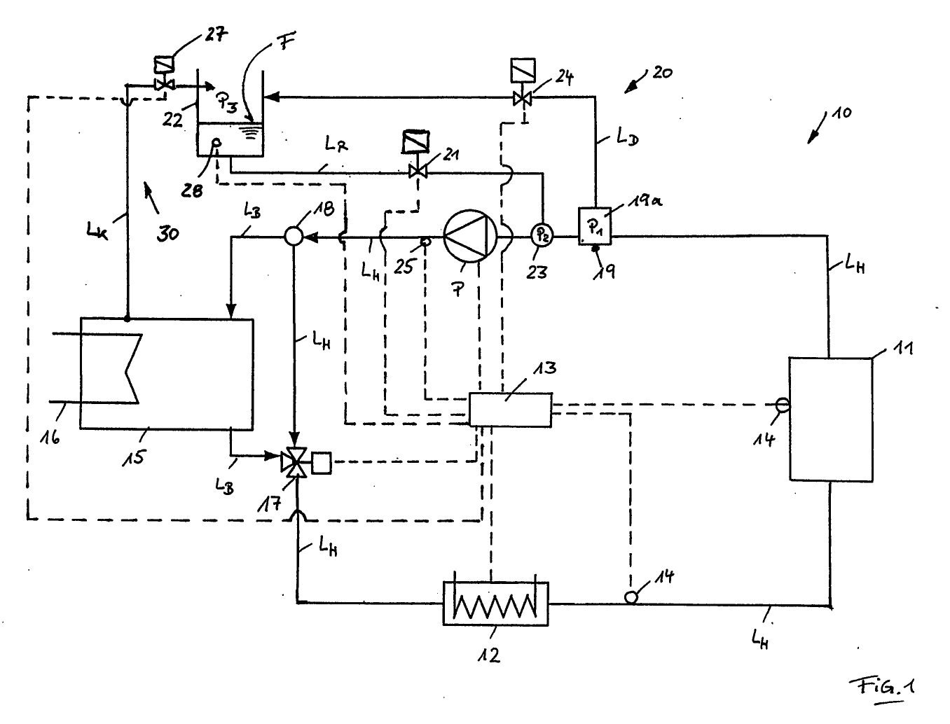

FIG. 1 shows a schematic flow diagram of an embodiment of an inventive tempering device;

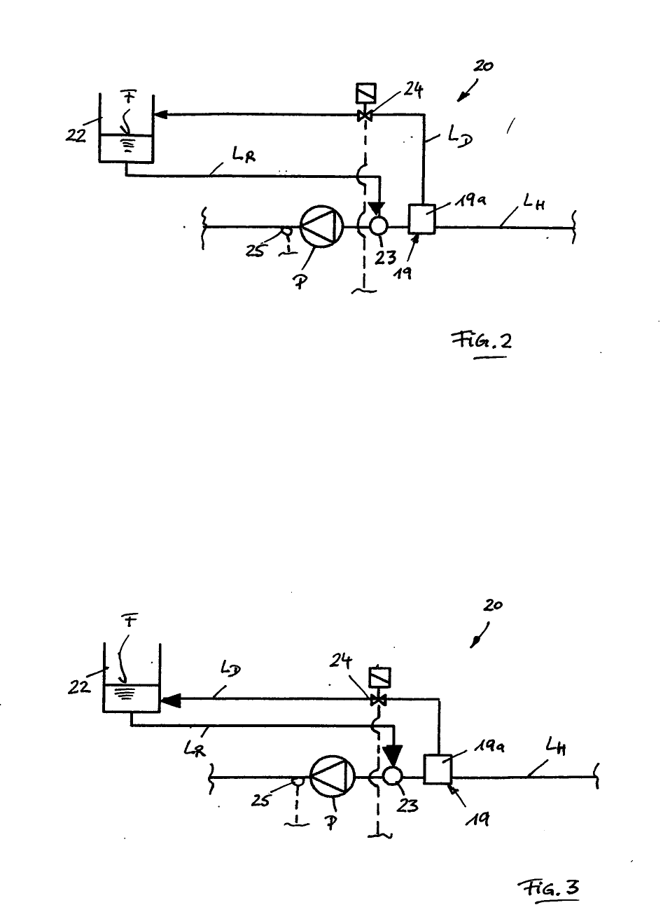

FIG. 2 shows only sections of a modification of the embodiment of FIG. 1;

FIG. 3 shows only sections of a further modification of the embodiment of FIG. 1;

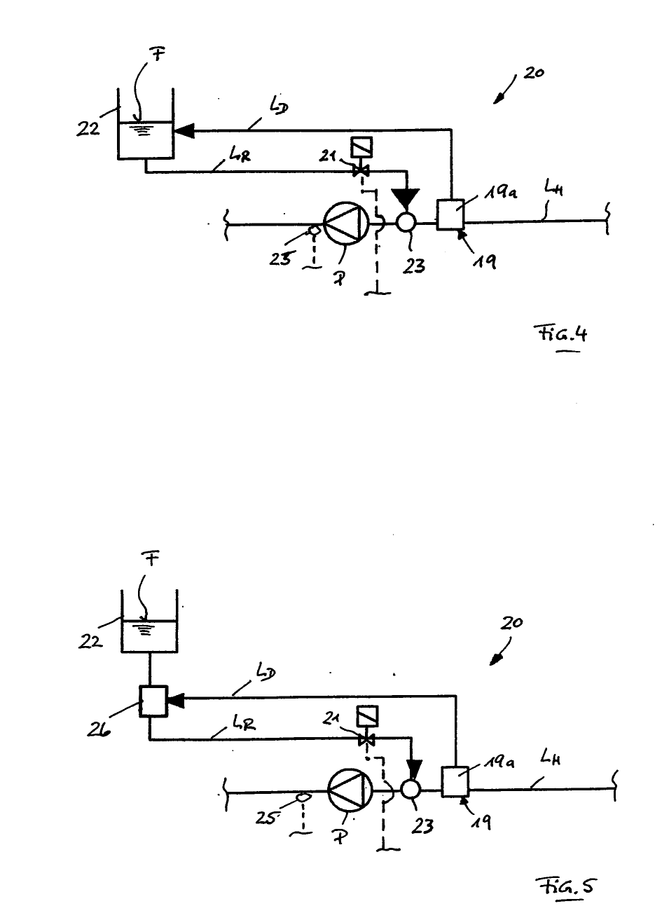

FIG. 4 shows sections of a modification of the embodiment of FIG. 3; and

FIG. 5 shows sections of an alternative embodiment of the tempering device.

FIG. 1 shows a tempering device 10 for tempering a consumption device 11, e.g. a reactor. The tempering device 10 has a tempering circuit L_{H} in which a tempering liquid is circulated by means of an electrically driven pump P, wherein the tempering liquid can flow through the consumption device 11 and temper it as desired.

Downstream of the pump P, a branch L_{B} is branched off at a branching point 18 that leads to a cold storage 15 which has an associated cooling device 16. A cooled tempering liquid is stored in the cold storage 15. The branch L_{B} extends from the cold storage 15 back to the tempering circuit L_{H}, where it terminates via a three-way control valve 17 which can be driven by a control unit 13. Via the three-way control valve 17, cooled tempering liquid from the cold storage 15 can be added to the tempering liquid that circulates in the tempering circuit L_{H} in dependence on the signals of the control unit 13.

A heating device 12 is disposed in the tempering circuit L_{H} downstream of the three-way valve 17, which is also driven by the control unit 13. The tempering liquid that circulates in the tempering circuit L_{H} can be heated when required using the heating device 12. Temperature sensors 14 are provided at several locations of the tempering circuit, which detect the actual temperature of the tempering liquid and/or the consumption device 11 and emit corresponding signals to the control unit 13.

The tempering device 10 moreover comprises a ventilation device 20 by means of which gas bubbles contained in the tempering liquid can be separated. A flow divider 19 in the form of a gravity separator 19a is disposed in the tempering circuit L_{H} upstream of the pump P, i.e. on its suction side, in which the less dense components of the entering tempering liquid rise and enter into a ventilation line L_{D} connected in the upper area of the gravity separator, such that a partial or side flow is branched off from the main flow of the tempering liquid that flows in the tempering circuit L_{H} and supplied to a ventilation tank 22 via the ventilation line L_{D} that houses a stop valve 24. As is shown in FIG. 1, the ventilation line L_{D} terminates above the liquid level F of the tempering liquid that collects in the ventilation tank 22 under atmospheric pressure. In this fashion, the pressure P₁ which prevails in the gravity separator 19a is larger than the pressure P₃ of the ventilation tank 22 which corresponds to the atmospheric pressure, such that the gas bubbles contained in the tempering liquid rise in the gravity separator 19a and enter the ventilation line L_{D}.

The ventilation tank 22 is moreover connected to the tempering circuit L_{H} via a feedback line L_{R} that also contains a stop valve 21. The feedback line L_{R} terminates in the tempering circuit L_{H} between the gravity separator 19a and the pump P at an opening location 23 where a pressure P₂ prevails which is smaller than the pressure P₁.

A temperature sensor 28 is associated with the ventilation tank 22, which detects the temperature of the tempering liquid that collects in the ventilation tank 22 and emits a corresponding signal to the control unit 13. The ventilation tank 22 is moreover associated with a cooling device 30 which comprises a cooling line L_{K} which extends from the cold storage 15 to the ventilation tank 22. A stop valve 27 is disposed in the cooling line L_{K}, which can be controlled by the control unit 13 via a corresponding line and can thus be opened or closed. If required, a cooled liquid, which is supplied from the cold storage 15 via the cooling line L_{K}, can be introduced, in particular, sprayed into the ventilation tank 22.

A pressure sensor 25 is disposed downstream of the pump P, in particular at its output, which measures the fluid pressure in the tempering circuit L_{H} and emits a corresponding pressure signal via a connecting line to the control unit 13. As is shown in FIG. 1, the control unit 13 is moreover connected to the pump P and the stop valve 24 of the ventilation line L_{D} and the stop valve 21 of the feedback line L_{R} via the corresponding connecting lines. Detection of a pressure drop at the output of the pump P by the pressure sensor 25 indicates an excessive gas or air portion in the tempering liquid. The control unit 13 then initiates a degassing process by opening the stop valve 24 of the ventilation line L_{D} and the stop valve 21 of the feedback line L_{R} and, if necessary, by additionally reducing the rotational speed of the pump P. The degassing process is continued until no excessive pressure drop at the output of the pump P has been determined by the pressure sensor 25 for a sufficiently long period of time.

During degassing of the tempering liquid, the stop valves 21 and 24 are opened and the pump P is activated, such that the tempering liquid circulates through the tempering circuit L_{H} and a small partial or side flow that is divided from the tempering circuit L_{H} in the gravity separator 19a and which may amount e.g. to approximately 4% to 5% of the overall flow, flows simultaneously via the ventilation line L_{D} to the ventilation tank 22 in which the gas bubbles are discharged to the atmosphere. The tempering liquid carried along in the partial or side flow is collected in the ventilation tank 22 and is returned to the tempering circuit L_{H} via the feedback line L_{R}. As soon as degassing of the tempering liquid is terminated, the stop valve 24 and, in corresponding applications if necessary also the stop valve 21, is/are closed and the actual tempering process of the consumption device 11 can be carried out as usual.

The embodiment of FIG. 2 substantially corresponds to the embodiment of FIG. 1 and differs therefrom only in that the stop valve in the feedback line L_{R} is omitted and the degassing process is controlled merely by driving of the stop valve 24 in the ventilation line L_{D}.

While in the embodiments of FIGS. 1 and 2, the ventilation line enters the ventilation tank 22 above the liquid level F of the liquid that collects in the ventilation tank 22, FIG. 3 shows an embodiment, wherein the ventilation line L_{D} terminates in the ventilation tank 22 below the liquid level F of the liquid contained in the ventilation tank 22.

In the embodiment of FIG. 3, a stop valve 24 is also only provided in the ventilation line L_{D}, while the feedback line L_{R} does not have a stop valve. A stop valve 21 may alternatively only be provided in the feedback line L_{R} as shown in FIG. 4, while the stop valve of the ventilation line L_{D} is omitted. In the embodiments of FIGS. 3 and 4, one stop valve 21, 24 may be provided in each of both the ventilation line L_{D} and the feedback line L_{R} (not shown).

FIG. 5 shows an alternative embodiment of the connection between the connecting line L_{D} and the ventilation tank 22. A further gravity separator 26 is provided in the feedback line L_{R} below the ventilation tank 22, in which the ventilation line L_{D} terminates. The partial or side flow that flows into the ventilation line L_{D} thus enters the further gravity separator 26 in which the specific light components, i.e. in particular gas and air bubbles rise, and enter the lower part of the ventilation tank 22. The denser components are returned to the tempering circuit L_{H} via the feedback line L_{R}.

FIG. 5 also shows only one stop valve 21 in the feedback line L_{R}. A stop valve may additionally or alternatively also be provided in the ventilation line L_{D}.

The embodiments of FIGS. 4 and 5 without stop valve in the ventilation line L_{D} enable the performance of a degassing process also during normal tempering operation of the tempering device. Air bubbles that are carried along in the tempering liquid can rise in the gravity separator 19a and enter the ventilation line L_{D}, and thereby enter into the ventilation tank 22.

1-14. (canceled)

15. A tempering device for tempering a consumption device using a tempering liquid in a tempering circuit, the device comprising:
a pump for circulating the tempering liquid;
a gravity separator disposed upstream of said pump, said gravity separator having a separator pressure;
a ventilation tank, said ventilation tank having an atmospheric pressure which is less than said separator pressure;
a ventilation line connected between said gravity separator and said ventilation tank;
a feedback line connected between said ventilation tank and a location of the tempering circuit disposed between said pump and said gravity separator to return tempering liquid that collects in said ventilation tank to the tempering circuit;
at least one stop valve disposed in said ventilation line and/or in said feedback line; and
a cooling device cooperating with said ventilation tank, wherein said gravity separator, said ventilation line, said ventilation tank, said feedback line, and said at least one stop valve cooperate to form a ventilation device for separating a gas contained in the tempering liquid, said gravity separator effecting flow division with which a partial flow of tempering liquid in the tempering circuit is supplied to said ventilation tank, wherein said ventilation line terminates in said ventilation tank below a level of liquid contained in said ventilation tank or terminates in said feedback line below said ventilation tank.

16. The tempering device of claim 15, wherein said ventilation line terminates in an upper area of said gravity separator.

17. The tempering device of claim 15, wherein said gravity separator has a separation chamber with a volume of 100 ml to 500 ml or 200 ml to 300 ml.

18. The tempering device of claim 15, wherein a cooled liquid can be introduced into said ventilation tank using said cooling device.

19. The tempering device of claim 15, wherein said partial flow in said ventilation line comprises 0.01% to 20% of an overall tempering liquid flow that enters said gravity separator.

20. The tempering device of claim 19, wherein said partial flow in said ventilation line comprises 2% to 8% of an overall tempering liquid flow that enters said gravity separator.

21. The tempering device of claim 15, wherein said the partial flow in said ventilation line comprises 4% to 5% of an overall tempering liquid flow that enters said gravity separator.

22. The tempering device of claim 15, further comprising a measuring device for determining said gas portion in the tempering liquid.

23. The tempering device of claim 22, wherein said measuring device determines a gas portion in the tempering liquid downstream of said pump.

24. The tempering device of claim 22, wherein said measuring device comprises a pressure sensor by means of which a fluid pressure in the tempering circuit can be detected and which emits a corresponding signal to a control unit.

25. The tempering device of claim 22, wherein said measuring device comprises a sensor for detecting a power input of said pump and to emit a corresponding signal to a control unit.

26. The tempering device of claim 22, wherein said measuring device comprises an optical sensor for detecting clouding of the tempering liquid and to emit a corresponding signal to a control unit.

27. The tempering device of claim 22, wherein said measuring device comprises a calorimetric means for identifying gas portions in the tempering liquid.

28. The tempering device of claim 26, wherein said pump and/or said stop valve can be driven by said control unit in dependence on said signal.
